(19) United States
(12) Patent Application Publication
(10) Pub. No.: US 2008/0284637 A1
(43) Pub. Date: Nov. 20, 2008

(54) DIGITAL TAS TRANSMITTER AND RECEIVER SYSTEMS AND METHODS

(75) Inventors: John C. Blessing, Spring Hill, KS (US); Edward W. Needham, Wellsville, KS (US); Jeffrey S. Hall, Overland Park, KS (US)

Correspondence Address: GARMIN INTERNATIONAL, INC.;ATTN: Legal - IP, 1200 EAST 151ST STREET, OLATHE, KS, 66062, US

(73) Assignee: GARMIN INTERNATIONAL, INC., Olathe, KS (US)

(21) Appl. No.: 12/020,986

(22) Filed: Jan. 28, 2008

Related U.S. Application Data
(60) Provisional application No. 60/892,006, filed on Feb. 28, 2007.

(51) Int. Cl. G01S 13/93

(52) U.S. Cl. 342/30

(57) ABSTRACT

A directional receiver is provided for an aircraft collision avoidance system. The receiver may include input channels that are configured to receive uncompressed linear analog signals from antenna elements that are arranged within a predetermined antenna element geometry. The receiver may further include Analog to Digital (A/D) converter modules, a quadrature converter module and a combiner module. The A/D converter modules can convert each of the analog signals to uncompressed linear digital data and output separate digital data streams that correspond to each of the input channels. The quadrature converter module can mix the digital data streams with corresponding digital reference signals to produce digital In-phase (I) and Quadrature (Q) streams.

### RELATED APPLICATION

The present application claims the benefit of U.S. Provisional Application No. 60/892,006, entitled “DIGITAL TAS TRANSMITTER AND RECEIVER SYSTEMS AND METHODS,” filed Feb. 28, 2007, which is herein incorporated by reference in its entirety.

### BACKGROUND

Embodiments of the present invention generally relate to directional transmitters and receivers for use in an aircraft, and more particularly to digital directional Traffic Advisory Systems (TAS) or Traffic Collision Avoidance Systems (TCAS I or TCAS II) transmitter and receiver systems and methods.

Today, systems exist for use in aircraft surveillance for collision avoidance and traffic alert. These conventional systems use active interrogation of Mode Select (Mode-S) and Air-Traffic Control Radar Beacon System (ATCRBS) transponders that can incorporate a passive phased array antenna. Conventional Mode-S and ATCRBS transponders transmit encoded messages containing information about the aircraft in response to interrogation signals received from ground based radar or from an aircraft with a Traffic Advisory System (TAS) or Traffic Collision Avoidance System (TCAS). When the transponder is not broadcasting, it monitors for transmissions including interrogation signals.

The Minimum Operating Performance Specifications (MOPS) for the TCAS II system is described in RTCA document DO-185A, “Minimum Operational Performance Standards for Air Traffic Alert and Collision Avoidance System II (TCAS II) Airborne Equipment”, dated December 1997 and the MOPS for TCAS I and TAS are embodied in RTCA document DO-197A, “Minimum Operational Performance Standards for Active Traffic Alert and Collision Avoidance System I (Active TCAS I)” both of which are incorporated herein by reference.

TAS, TCAS I, and TCAS II equipment transmit interrogation signals that are received and replied to by other aircraft and used to determine the location of other aircraft relative to the originating aircraft position. Conventional TAS, TCAS I, and TCAS II systems may include a 4-element interferometer antenna coupled, to a remote radio frequency (RF) transmitter/receiver. The transmitter and receiver are coupled to the antenna array by multiple low loss coaxial transmission lines. The antenna arrays utilized by conventional TCAS systems are “passive” in that all of the power utilized to drive the antenna array elements is produced at the remote transmitter assembly. Similarly, all of the power that is used to boost the receive range of conventional antenna arrays are provided at the remote receiver assembly.

The transmitter and receiver are in turn coupled to a signal processor that controls transmission and reception of TAS and TCAS related information and that performs aircraft surveillance operations, such as traffic alert and collision avoidance operations. The transmitter is coupled to the signal processor for transmitting, among other things, interrogation signals. A control panel and display are joined to the signal processor for operating the TAS/TCAS system and for displaying TAS/TCAS information.

The TCAS system identifies the location and tracks the progress of aircraft equipped with beacon transponders. Currently, there are three versions of the surveillance systems in use; TAS, TCAS I, and TCAS II. TAS is the simplest and least expensive of the alternatives, while TCAS I is less expensive but also less capable than TCAS II. The TAS and TCAS I transmitter sends signals and interrogates ATCRBS transponders. The TAS and TCAS I receiver and display indicate approximate bearing and relative altitude of all aircraft within the selected range (e.g., about forty miles). Further, the TAS and TCAS system uses color coded dots to indicate which aircraft in the area pose a potential threat (e.g., potential intruder aircraft). The dots are referred to as a Traffic Advisory (TA). When a pilot receives a TA, the pilot then visually identifies the intruder aircraft and is allowed to deviate up to +300 feet vertically. Lateral deviation is generally not authorized. In instrument conditions, the pilot notifies air traffic control for assistance in resolving conflicts.

The TCAS II system offers all of the benefits of the TCAS I system, but can also issue a Resolution Advisory (RA) to the pilot. In the RA, the intruder target is plotted and the TCAS II system determines whether the intruder aircraft is climbing, diving, or in straight and level flight. Once this is determined, the TCAS II system advises the pilot to execute an evasive maneuver that will resolve the conflict with the intruder aircraft. Preventive RAs instruct the pilot not to change altitude to avoid a potential conflict. Positive RAs instruct the pilot to climb or descend at a predetermined rate of 2500 feet per minute to avoid a conflict. TCAS II is capable of interrogating Mode-C and Mode-S. In the case of both aircraft having Mode-S interrogation capability, the TCAS II systems communicate with one another and issue de-conflicted RAs.

Conventional aircraft collision avoidance systems utilize receivers that are omni-directional and may use analog logarithmic and amplitude limited devices in the receiver chain to process both amplitude and phase data. Each antenna element is coupled to a separate receive channel within the receiver. Each receive channel includes an RF filter, a local oscillator, an IF filter, a logarithmic detector and an amplifier. The RF filter receives a high frequency (e.g., 1090 MHz) receive signal from the corresponding antenna element. The high frequency receive signal is mixed with a LO signal from a local oscillator (e.g., 1030 MHz) to reduce the receive signal to an intermediate frequency (IF). The IF signal is then passed through an IF filter. An output of the IF filter is supplied to a logarithmic detector. The logarithmic detector compresses the IF signal in accordance with a log scale to form a non-linear, compressed video signal that is amplified and provided as the channel output. The log-video signal represents a DC signal that has a power output level representative of the receive signal strength. The log-video output of each channel is subsequently digitized and supplied to the processor circuit to compute among other things the relative signal strength of the intruder aircraft. In addition, the amplitude-limited output of the same signal is supplied to a phase detector circuit to derive the bearing to the intruder.

However, conventional receivers continue to exhibit certain limitations. Given the type of logarithmic amplifiers available in the past the receivers may require high current to operate which would consume a substantial amount of power subsequently produce a significant amount of heat during operation. Further, conventional receivers utilize, for each channel, a separate log detector for signal strength, as well as separate limited outputs for the phase measurements, which increase the parts count, complexity, and the power demand of the overall system. Such analog receivers may be relatively large and expensive.

Moreover, conventional transmitters have also experienced certain limitations. Conventional transmitters generally utilize a crystal oscillator that produces an analog reference signal at a predetermined amplitude and frequency. The analog reference signal may be up-converted to a desired frequency and both amplitude modulated and phase modulated (e.g. BPSK) depending on the interrogation requirements. Phase control is then subsequently implemented to form directional beam transmit patterns. However, conventional transmitters are expensive and require a large number of components. Also, conventional transmitters must implement the amplitude and phase control circuitry at high power. Implementing either amplitude or phase control circuitry at high power is difficult and requires expensive components. Further, the amplification components are nonlinear and present challenges to precisely maintain at a given level of power or phase or spectral purity.

### SUMMARY

In accordance with one embodiment, a directional receiver is provided for an aircraft collision avoidance system. The receiver includes input channels that are configured to receive uncompressed linear analog signals from antenna elements that are arranged within predetermined antenna element geometry. The receiver includes Analog to Digital (A/D) converter modules, a quadrature converter module and a combiner module. The A/D converter modules convert each of the analog signals to uncompressed linear digital data and output separate digital data streams that correspond to each of the input channels. The quadrature converter module mixes the digital data streams with corresponding digital reference signals to produce digital In-phase (I) and Quadrature (Q) data streams that are associated with each of the input channels. The reference signals have phase differences there between to produce I and Q data streams. The combiner module combines the I and Q data streams to form a directional or omni-directional beam-former data stream, which represents a directional receive sensitivity pattern or omni-directional receive sensitivity pattern, respectively.

In accordance with at least one embodiment, a digital logarithmic module is provided to receive and convert the directional beam-former data stream to a directional logarithmic video data stream. The directional beam-former data stream represents a non-logarithmic, non-compressed data stream prior to conversion at the logarithmic module. The combiner module includes a first summer to sum the I data streams and a second summer to sum the Q data streams to form summed I and Q data streams, respectively, that are uncompressed and linear prior to being supplied to the logarithmic module.

In accordance with at least one embodiment, the quadrature converter module includes a plurality of look-up tables. Each Look-Up Table (LUT) stores a digital representation of a reference signal. The quadrature converter module accesses the look-up tables at LUT addresses that are offset with respect to one another in order to define a phase difference between the reference signals. The quadrature converter module may organize the look-up tables such that each input channel is associated with first and second look-up tables stored representations of a common reference signal. The quadrature converter module would access the first and second look-up tables in an offset manner to define a phase shift of approximately 90° there between to form in-phase and quadrature reference signals for the corresponding input channel.

In accordance with another embodiment, one look-up table per receiver channel may be used, each of which can be read at the same address. The processor module can re-write the appropriate values stored in each LUT to vary the reference signal phase. The outputs of the LUTs can be the in-phase reference signals. A register delaying the in-phase reference signals can produce the quadrature signals.

In accordance with at least one embodiment, the reference signals are organized into first and second pairs of in-phase and quadrature reference signals that are mixed with corresponding first and second digital data streams from first and second antenna elements, respectively. The first and second quadrature reference signals can lag behind the first and second in-phase reference signals, respectively, by approximately 90°. The phases of the reference signals can be chosen based on insertion phase differences between the receiver channels including the transmission lines and the desired receive sensitivity pattern. The phase relationship between the first and second in-phase and quadrature reference signals can create a receive sensitivity pattern extending from the first and second antenna elements. Optionally, the quadrature converter module may control the reference signals so that a pair of signals of one common phase fed to the first pair of antenna elements and a pair of signals of a different phase fed to the second pair of antenna elements produces a maximum directional beam-former signal. The reference signals may be compensated for insertion phase differences between the receiver channels including the transmission lines.

In accordance with an alternative embodiment, a method is provided for controlling a directional receiver within an aircraft collision avoidance system. The method includes receiving uncompressed, linear analog signals, over input channels, from antenna elements located within a predetermined antenna element geometry. The method includes converting each of the linear analog signals to uncompressed linear digital data and outputting separate digital data streams for each of the input channels. The method further includes mixing the digital data streams with corresponding digital reference signals to produce digital in-phase and quadrature converted data streams associated with each of the input channels. The reference signals have phase differences there between to produce I and Q data streams. The phase differences of the reference signals can correct for the insertion phase differences between the receiver channels including the transmission lines and also set the desired receive pattern. The I and Q data streams are combined to form a directional beam-former data stream.

Optionally, the directional beam-former data stream may be converted to a directional log-video data stream, where the directional beam-former data stream represents a non-logarithmic, non-compressed data stream prior to logarithmic conversion. Optionally, the method may include summing the I data streams and summing the Q data streams to form summed I and Q data streams, respectively, that are uncompressed and linear. The reference signals may be produced by accessing the plurality of look-up tables where each of the look-up tables stores a digital representation of the reference signal. The look-up tables are accessed at addresses that are offset with respect to one another to define a phase difference between the reference signals.

Alternatively, creation of reference signals may involve one look-up table per receiver channel. Writing different values to each look-up table can define its phase. Reading of all look-up tables can be done generally simultaneously at the same address on all look-up tables. Reading from the look-up tables in this manner creates the in-phase reference signals and delaying the in-phase reference signals by an integer number of clock cycles equivalent to approximately 90° produces the quadrature reference signals.

In accordance with an alternative embodiment, a digital transmitter is provided for an aircraft collision avoidance system. The transmitter includes a phase control module that generates digital baseline reference counter values. The phase control module includes a single phase accumulator that sets the programmable frequency and common phase of the output signals. The transmitter further includes a Phase-to-Amplitude (P/A) module that receives the reference counter-values and produces, based thereon, separate digital transmit signals for each transmit channel. The transmitter includes digital-to-analog converters that convert the digital transmit signals to analog transmit signals. The analog transmit signals are configured to drive corresponding antenna elements after proper up-conversion and amplification.

Optionally, the transmitter may include phase offset modules associated with each of the transmit channels that introduce, into the reference counter values, offsets associated with corresponding ones of the transmit channels. The P/A modules may be implemented as look-up tables that store a digital representation of a transmit signal. The reference counter values may define pointers into the look-up tables to access LUT addresses in a desired order and sequence.

In accordance with an alternative embodiment, a method is provided for controlling a digital transmitter for an aircraft collision avoidance system. The method includes generating digital reference counter-values that are programmable to adjust a frequency and phase of the reference counter-values. Setting the frequency of the system and setting the common offset of the reference counter values may be done using a single phase accumulator. Creation of the reference counter sequence is performed by the single phase accumulator. The method includes converting the reference counter values into separate digital transmit signals associated with different transmit channels and converting the digital transmit signals to analog transmit signals. Up-converting and amplifying the analog transmit signals produces the signals used to drive corresponding antenna elements.

### BRIEF DESCRIPTION OF THE DRAWINGS

FIG. 1 illustrates a block diagram of a surveillance system formed in accordance with an embodiment of the present invention.

FIG. 2 illustrates a detailed block diagram of a directional digital receiver formed in accordance with an embodiment of the present invention.

FIG. 3 illustrates a graphical representation of a set of look-up tables that may be implemented in the directional digital receiver of FIG. 2 in accordance with an embodiment of the present invention.

FIG. 4 illustrates an exemplary geometry in which the antenna elements may be arranged on an antenna PCB.

FIG. 5 illustrates a block diagram of a direct digital synthesizer module that is joined to a transmit module in accordance with an embodiment of the present invention.

FIG. 6 illustrates a graphical representation of a set of look-up tables that may be implemented in the digital synthesizer module of FIG. 5 in accordance with an embodiment of the present invention.

### DETAILED DESCRIPTION

Embodiments of the present invention are described in connection with a Traffic Avoidance System (TAS), or Traffic Collision Avoidance System (TCAS I or TCAS II). However, it is understood that the present invention may be utilized in other aircraft surveillance applications.

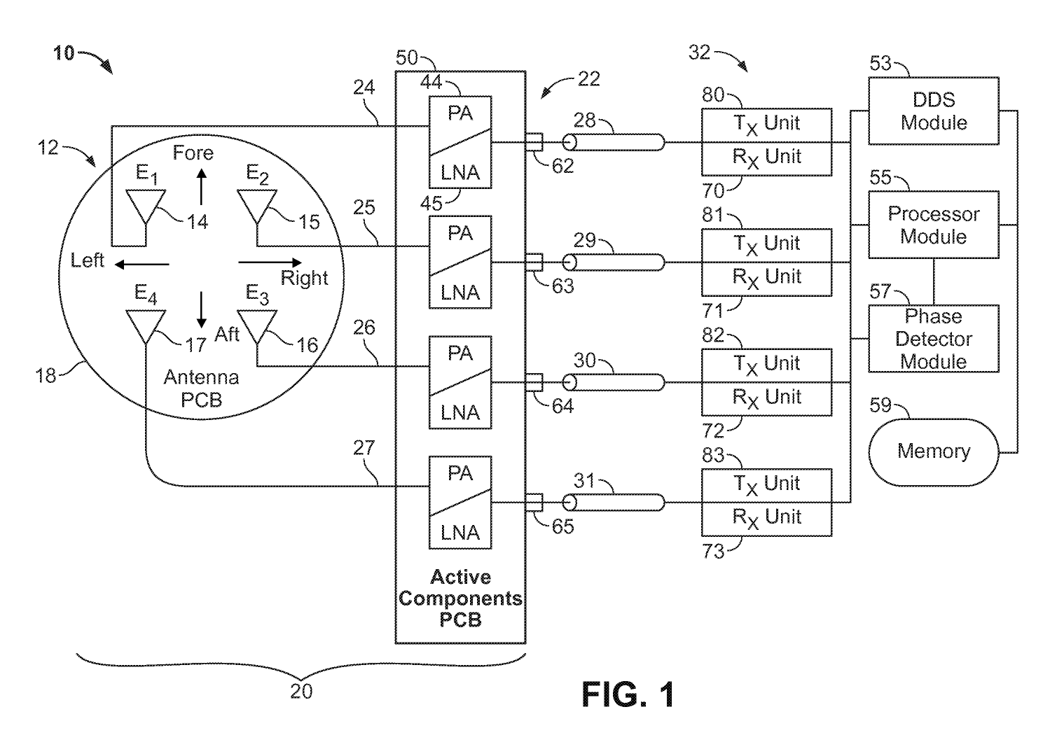

FIG. 1 illustrates a block diagram of an active phased array antenna system 10 that is formed in accordance with an embodiment of the present invention. The system 10 includes an antenna array 12 that comprises a plurality of antenna elements 14-17, each of which is mounted to a common antenna Printed Circuit Board (PCB) 18. The antenna array 12 forms part of an antenna module 20 that is configured to be mounted to an aircraft. The antenna elements 14-17 transmit and receive Radio Frequency (RF) transmit and receive signals, for example at 1030 MHz and 1090 MHz, respectively. The antenna elements 14-17 collectively transmit RF transmit signals at an Effective Radiated Power (ERP). Antenna gain can be typically 3 dB or twice the incident power for an active phased directional array, such that a 400 Watt (W) ERP will typically require about 200 W to be cumulatively delivered to the four antenna elements, or about 50 W to be delivered to each of the four antenna elements. Each antenna element 14-17 communicates over a separate physical channel 24-27 within the antenna module 20.

The antenna module 20 may include first and second circuit boards configured to be mounted to the exterior and interior, respectively, of an aircraft. The antenna module 20 includes an active component PCB 50 that is interposed between the antenna PCB 18 and transmission lines 28-31. The active component PCB 50 includes power amplifiers 44 and low noise amplifiers 45 in each of channels 24-27. The power amplifiers 44 are utilized during transmission operations. The power amplifiers 44 are provided on the antenna module 20 along each transmit path and operate to increase a power level of the electrical transmit signals, received from the transmission lines 28-31, by an amount sufficient to drive the corresponding antenna element 14-17 to the ERP. For example, the antenna module 20 receives, from the transmission lines 28-31 (that collectively defined the communications link), the transmit signals at a power level of between 1 W and 10 W, and more preferably between 4 W and 8 W. Each of the antenna elements 14-17 are driven by RF signals at a power level substantially higher than 10 W, such as between 40 W and 80 W.

The low noise amplifiers 45 are provided along receive paths on the active component PCB 50. The low noise amplifiers 45 increase a power level of electrical receive signals, received by the antenna elements 14-17, before outputting the electrical receive signals onto the transmission lines 28-31.

The antenna module 20 includes a connector module (generally denoted 22) that includes separate coaxial connector elements 62-65 that are associated with each of the channels 24-27. The connector module 22 is configured to couple transmission lines 28-31 with associated corresponding channels 24-27, respectively. Each transmission line 28-31 transmits and receives electrical transmit and receive signals, respectively, from and to a remote Transmit/Receive (T/R) unit 32. For example, the T/R unit 32 transmits interrogation signals to the antenna array 12 and receives reply information from the antenna array 12. The connector module 22 receives the transmit signals at a power level that is less than the ERP at which the RF transmit signals are transmitted from the antenna elements 14-17.

The T/R unit 32 includes transmitter units 80-83 and receiver units 70-73 that are joined to corresponding transmission lines 28-31. The transmission lines 28-31 may be coaxial lines that convey transmit and receive signals between the antenna module 20 and the transmit/receive unit 32. The transmission lines 28-31 convey the transmit and receive signals at low power (e.g. less than 10 W). The transmitter units 80-83 and receiver units 70-73 are joined to a Direct Digital Synthesis (DDS) module 53, a processor module 55 and a phase detector module 57. The processor module 55 and DDS module 53 communicate with the phase detector module 57 and access memory 59 to store and retrieve information. The DDS module 53 performs beam forming in connection with transmit operations. The DDS module 53 provides transmit signals to the transmitter units 80-83 that output low power transmit signals over the transmission lines 28-31. The transmit signals are output by the transmitter units 80-83 at low power, such as between 1 W and 10 W, or more preferably between 4 W and 8 W. The transmit signals are output at a power output level substantially below that received by the antenna array 12 and the ERP produced by the antenna array 12. For example, the transmit units 80-83 may generate transmit signals at a power of about 6 W, while the ERP produced at the antenna array 12 is preferably about 400 W.

The phase detector module 57 receives, from the receiver units 70-73, receive signals that are received at the antenna elements 14-17. The phase detector module 57 determines, among other things, phase differences between the receive channels. The processor module 55 may utilize the phase differences to derive phase calibration offsets that are associated with each channel 24-27. The phase calibration offsets correct for insertion phase introduced by the transmission lines 28-31, components within the T/R unit 32, components upon the active component PCB 50 and the like. In addition, the processor module 55 may ultimately utilize these receive signals processed by the phase detector module 57 to provide bearing information on intruder aircraft corrected by the aforementioned calibration offsets.

The processor module 55 receives from the receiver units 70-73, receive signals that are received at the antenna elements 14-17. The processor module 55 determines, among other things, rise times of pulse amplitude modulated reply waveforms and squitter transmissions emanating from both solicited or unsolicited transponder transmissions, fall times of said signals, and amplitude levels of said signals on each receive channels. The processor module 55 may utilize this information among other things to identify and track aircraft.

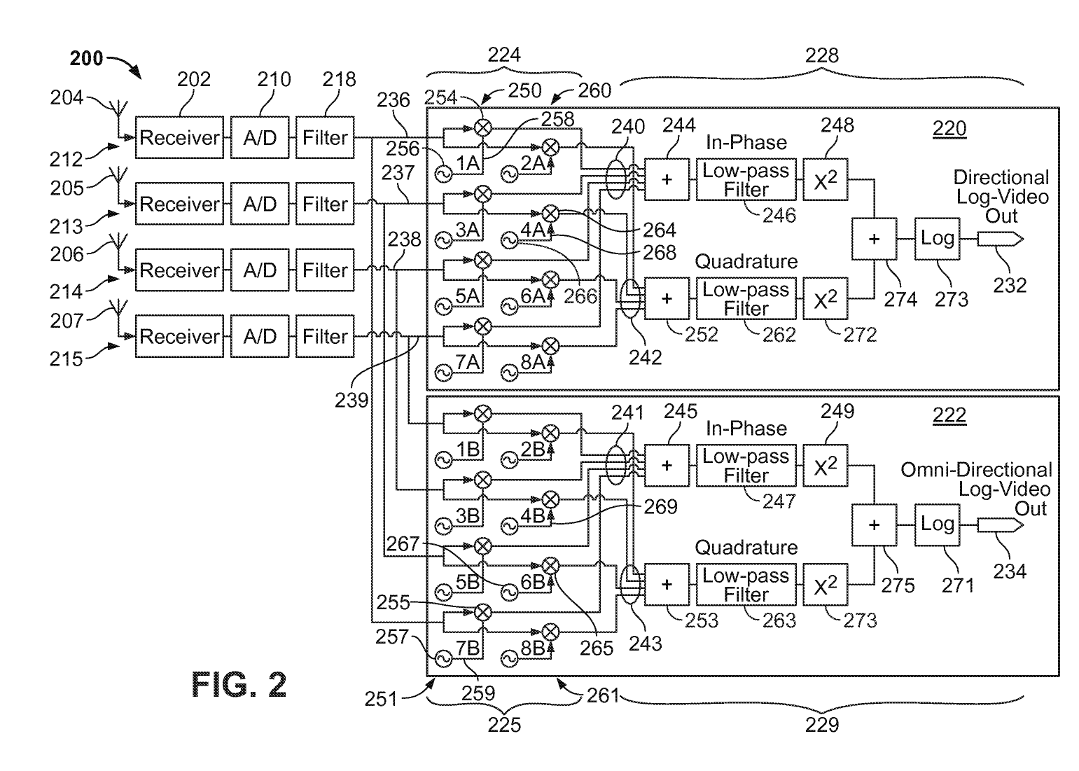

FIG. 2 illustrates a block diagram of a digital receiver 200 formed in accordance with an embodiment of the present invention. The receiver 200 is joined to individual antenna elements 204-207. Each antenna element 204-207 is associated with a separate input channel 212-215 that conveys uncompressed, linear analog signals from the antenna elements 204-207 through analog receiver module 202, Analog to Digital (A/D) converters 210 and filters 218. Each receiver module 202 includes filters, amplifiers, and mixers that process and down convert received RF signals to Intermediate Frequency (IF) signals. The IF signals that are output from receiver modules 202 represent uncompressed, linear analog signals and are passed to the Analog to Digital (A/D) converters 210. The A/D converters 210 convert the uncompressed, linear analog signals from the receiver modules 202 into uncompressed, linear digital data streams. The term “linear” as used throughout shall mean that each step change in a data value corresponds to an equal, proportional step change in the received RF signal amplitude regardless of where the data value lies along the dynamic range of the A/D converter 210. The A/D converters 210 output separate digital data streams corresponding to each of the input channels 212-215. The digital data streams are passed through filters 218 which highpass or bandpass filter the data in order to block any DC component within the digital data stream.

In the example of FIG. 2, four channels 212-215 are illustrated although it is understood that more or fewer channels may be utilized. In the example of FIG. 2, the A/D converters 210 are located between the receiver modules 202 and the filters 218. Optionally, the A/D converters 210 may be placed in another position within the corresponding channel 212-215, such as after the filters 218.

The receiver 200 includes a directional beam-former module 220 and an omni-directional beam-former module 222. In the illustrated example, a single directional beam-former module 220 is provided to receive input channels 212-215 for all of the antenna elements 204-207 and output, based thereon, a single directional beam-former signal. Optionally, the directional beam-former signal may be converted to a directional log-video output 232 by a logarithmic operation. Alternatively, the directional beam-former module 220 may be duplicated into multiple modules to provide multiple directional beam-former signals for simultaneous directional beams.

The directional beam-former module 220 receives data streams 236-239 over input channels 212-215. A quadrature converter 224 mixes the incoming digital data streams 236-239 with corresponding digital reference signals 258 and 268 (as explained below in more detail) to produce In-phase (I) and Quadrature (Q) data streams (collectively noted at 240 and 242, respectively) that are associated with each of the antenna elements 204-207. The directional beam-former module 220 also includes a combiner module 228 that combines corresponding I and Q data streams 240 and 242 to form the directional beam-former data stream and optionally the directional log-video output 232.

The quadrature converter 224 includes in-phase and quadrature components 250 and 260 that receive the digital data streams 236-239 and produce corresponding sets of I and Q data streams 240 and 242. The in-phase components 250 include mixers 254 and local oscillators 256 associated with each data stream 236-239 from each input channel 212-215. The local oscillators 256 produce the reference signals 258 in a digital format. The reference signals 258 are joined by mixers 254 with corresponding digital data streams 236-239. The quadrature components 260 include mixers 264 and local oscillators 266 associated with each data stream 236-239 from each input channel 212-215. The local oscillators 266 produce digital reference signals 268 that are joined by mixers 264 with corresponding digital data streams 236-239. The quadrature converter 224 generates the reference signals 258 of the in-phase components 250 with phase differences from the quadrature components 260 in order to produce the in-phase and quadrature data streams 240 and 242. Each in-phase reference signal 258 can be approximately 90° ahead of its corresponding quadrature reference signal 268. The quadrature converter 224 also generates the reference signals 258 of the in-phase components 250 different from one another and the reference signals 268 of the quadrature components 260 different from one another in order to form a receive pattern based on the antenna geometry and the receiver calibration offsets that compensate for relative insertion phase differences between individual receive channels 212-215. By way of example, the local oscillators 256 and 266 may be implemented through a plurality of look-up tables, where each look-up table stores a digital representation of a corresponding reference signal.

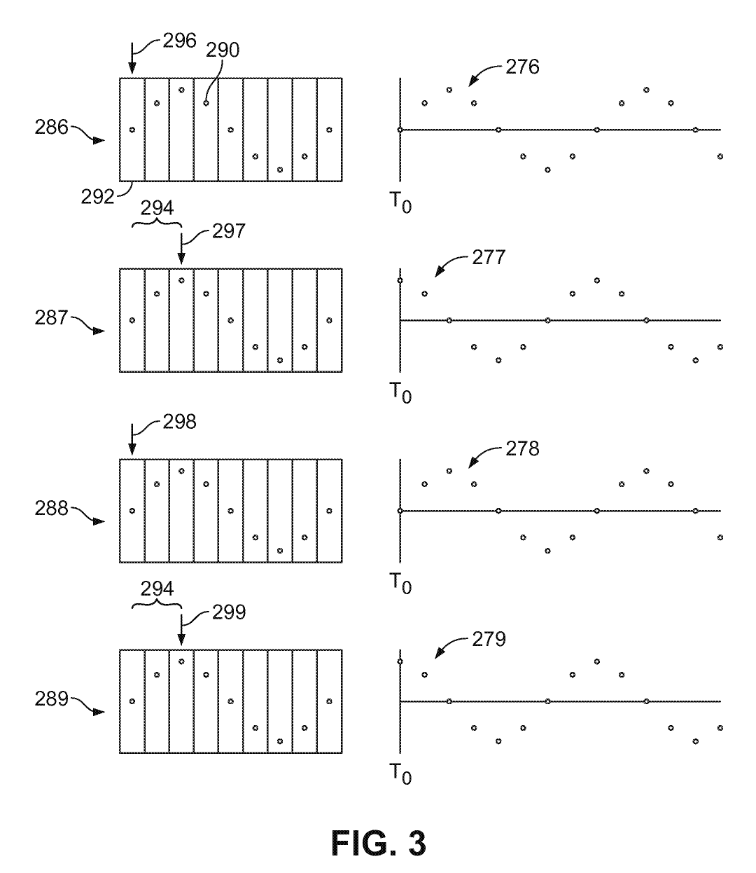

FIG. 3 illustrates a graphical representation of a set of Look-Up Tables (LUTs) 286-289 that may used as the implementation of the local oscillators 256 in the in-phase components 250. A separate LUT 286-289 is used for each channel 212-215. The Look-Up Tables 286-289 store digital data values 290 at LUT addresses 292 that correspond to the data points along one or more cycles of a sine wave. Each of the look-up tables 286-289 stores a common sine wave. By way of example in FIG. 3, a single 360° cycle of a sine wave is shown and is represented by eight data values 290 and thus adjacent data values 290 are separated by 45° intervals. Although it is understood that a substantially greater number of data values 290 may be utilized and thus adjacent data values would be separated by a substantially smaller intervals than 45°. The data values 290 are read out from corresponding look-up tables 286-289 based on the locations of pointers 296-299, respectively. In FIG. 3, the pointers 296-299 are shown at a representative point in time, such as a starting point. The pointers 296-299 do not point to a common address in all of the look-up tables 286-289. Instead, the pointers 296-299 are shown to point to LUT addresses 292 that are offset 294 with respect to one another. The offsets 294 between LUT addresses 292 in the LUT 286-289 of the in-phase components 250 introduce a phase difference between reference signals that are produced from each of the look-up tables 286-289 as the sine waves are read out.

The quadrature components 260 may implement a set of look up tables similar to LUTs 286-289 but with the pointers all uniformly offset from the pointers 296-299 of the in-phase components 250. The difference between each in-phase pointer 296-299 and its corresponding quadrature pointer may be approximately 90° to produce quadrature.

As the pointer 296-299 sequences through the LUT addresses 292 into corresponding look-up tables 286-289, reference signals 276-279 are generated, respectively. The reference signals 276-279 correspond to the reference signals 258 (FIG. 2) that are produced by the oscillators 256 along each channel 212-215 in the in-phase components 250. The reference signals 276-279 are shown to be aligned along a common time axis starting at time T0. By way of example, the reference signal 276 is shown aligned in-phase with reference signal 278, while reference signal 277 is aligned in-phase with reference signal 279. Again, by way of example, reference signals 276 and 278 are shown shifted by a 90° phase difference from reference signals 277 and 279. It is understood that a similar set of LUTs in the quadrature components 260 would generate reference signals similar to reference signals 276-279 (FIG. 3), but shifted 90°.

The offsets 294 between pointers 296-299 are controlled and adjusted to achieve an antenna phase pattern. The antenna phase pattern refers to a group or pattern of phase differences that are assigned to the antenna elements of an antenna system. Antenna systems may utilize different geometries for the antenna elements and may have different desired gain sensitivity patterns. Once an antenna element geometry is determined and the sensitivity pattern(s) selected, the phase differences between channels are calculated based off of this antenna geometry and previous calibrations that accounts for insertion phase attributable to the components of each channel. Once the phase differences between channels are determined, the offsets 294 between the pointers 296-299 are determined.

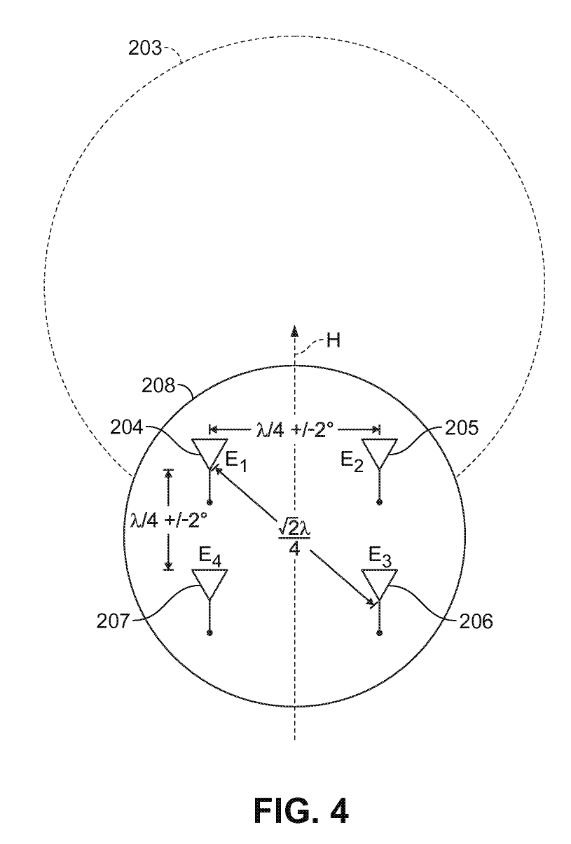

FIG. 4 illustrates an exemplary geometry in which the antenna elements 204-207 may be arranged on an antenna PCB 208. The antenna elements 204-207 are spaced apart from one another in a square pattern and arranged relative to the heading H of the aircraft such that antenna elements 204 and 205 are spaced equal distances apart and located transversely on opposite sides of the heading H. Antenna elements 206 and 207 are also spaced equal distances apart and located transversely on opposite sides of the heading H. Antenna elements 206 and 207 trail the antenna elements 205 and 204 relative to the direction of the heading H. Antenna element 205 is located adjacent antenna elements 204 and 206, while antenna element 206 is located adjacent antenna elements 207 and 205. Antenna elements 204 and 206 are located cross from one another, while antenna elements 207 and 205 are located cross from one another.

Utilizing the configuration of FIG. 4, adjacent antenna elements are spaced apart by one quarter of the wavelength (λ/4) of the carrier signal utilized to drive the antenna elements 204-207. Thus, cross antenna elements are spaced apart by \sqrt{2}(λ/4) of the carrier signal. RF calibration signals transmitted from antenna element 204 will be received at antenna element 205 within a quarter (λ/4) wavelengths. Thus, an autonomous receive calibration processing sequence can utilize the specific geometry of the antenna elements 204-207 to compensate for cable and receiver insertion phase differences between channels. The reference adjacent and cross element phase differences so derived are stored and used to determine the offsets 294 between pointers 296-299 into look-up tables 286-289.

Returning to FIG. 3, the look-up table 286 and look-up table 288 are implemented in channels 212 and 213 (FIG. 2) such that corresponding reference signals 276 and 278 are mixed with the digital data streams 236 and 237, respectively, that are received from antenna elements 204 and 205. The look-up tables 287 and 289 are implemented in connection with channels 214 and 215 to be mixed with digital data streams 238 and 239, respectively, from antenna elements 206 and 207. In this example there is no insertion phase difference between channels. If there was an insertion phase difference then each of the four reference signals could be adjusted by the offsets created by the insertion phases.

The quadrature converter 224 controls the pointers 296-299 in the LUTs 286-289 such that reference signals 276 and 278 form a first pair of in-phase reference signals having a common first reference phase. LUTs 287 and 289 produce reference signals that form a second pair of in-phase reference signals 277 and 279 having a common second reference phase. The phase of reference signals 276 and 278 differs from the phase of reference signals 277 and 279. In the example of FIG. 3, the first pair of reference signals 276, 278 are phase shifted 90° with respect to the second pair of reference signals 277, 279. The first and second pairs of in-phase reference signals 276, 278 and 277, 279 are mixed with corresponding first and second pairs of digital data streams 238, 239 and 236, 237, respectively. Mixing the reference signals 276-279 and data streams 236-239 in the foregoing manner creates a receive sensitivity lobe 203 having increased sensitivity or gain in a direction extending from the first and second pairs of antenna elements 204, 205 and 207, 206. FIG. 4 illustrates an exemplary sensitivity lobe that may be created when shifting the phases of the reference signals 276-279 in the manner illustrated in FIG. 3. In FIG. 4, the sensitivity lobe 203 has increased sensitivity in the direction of heading H. These phase relationships may be affected by the design of the down-converter in receiver module 202 such as whether high side or low side injection is used. Once again, in this example there is no insertion phase difference between channels. If there was an insertion phase difference then each of the four reference signals could be adjusted by the offsets created by the insertion phases.

Alternatively, the sensitivity lobe 203 may be directed in other directions, such as to the right or left of heading H. As a further option, the sensitivity lobe 203 may be directed in an opposite direction along heading H. The direction of the sensitivity lobe 203 is controlled by adjusting the phase differences between the in-phase reference signals 258 generated by the local oscillators 256 (FIG. 2). The quadrature reference signals 268 generated by the local oscillators 266 may always lag behind the in-phase reference signal 258 by approximately 90° (FIG. 2).

Alternatively, a first set of the Look-Up Tables 286-289 may store a first common reference signal (e.g. a sine wave), while a second set of the look-up tables may store a different second reference signal (e.g. a cosine wave). Addresses within a look-up table 286-289 are accessed to read out digital data points along the reference signal. The pointers 296-299 may also be adjusted to account for phase differences experienced along the channels 212-215. For example, if channel 212 exhibits a quarter wavelength phase lag behind channel 213 due to phase losses created along the channel 212, then pointer 296 would be shifted back a quarter of a wavelength to lag pointer 298.

Alternatively, the Look-Up Tables 286-289 may contain one LUT per receiver channel 212-215. All four LUTs 286-289 could be read at identical addresses 296 and could be read consecutively. The processor module 55 can adjust the phase associated with each LUT by writing different values (shifted values along a sine wave) to the LUT. Thus, rather than shifting pointers to create phase differences, the data values 290 written within the LUTs 286-289 can be shifted along an ideal sine wave. For example to get a 0° sine wave the following values could be written to a four address LUT: 0, 1000, 0, and −1000. To change the waveform to a 45° waveform the following values could be written: 707, 707, −707, and −707. The values read directly from the LUTs 286-289 are the in-phase reference signals 258 while the quadrature signals 168 can be produced by delaying the in-phase reference signals by an integer number of clock cycles by using a delay module which creates a 90° shift. That delay module can either be a register or a shift register. For example, if the four repeated values of the in-phase waveform sequence produced by the LUT are 0, 1000, 0, and −1000, then the four repeated values of the quadrature waveform sequence produced by the delay are −1000, 0, 1000, and 0.

Returning to FIG. 2, the combiner module 228 includes a summer 244 that sums the I data streams 240 and provides the summed linear I data to a low-pass filter 246. The low-pass filter 246 passes the low frequency component of the summed I data to a square calculation module 248 which calculates the square of the filtered summed data stream. The combiner module 228 also includes a summer 252 that sums the Q data streams 242 and passes linear summed Q data to a low-pass filter 262 which passes the low frequency component of the summed signal to a square calculation module 272. The squared outputs of the square calculation modules 248 and 272 are passed through a summer 274 which sums the signals to form a directional beam-former data stream. The summer 274 provides the directional beam-former data stream to a logarithmic calculation module 273. The logarithmic calculation module 273 produces a directional log-video output 232 which is no longer linear, but instead represents a logarithmic representation of the incoming data stream from the summer 274.

Returning to FIG. 2, the receiver 200 also includes an omni-directional beam-former module 222. The omni-directional beam-former module 222 is connected to each of the digital data streams 236-239. The omni-directional beam-former module 222 includes a quadrature converter 225 that mixes incoming digital data streams 236-239 from the input channels 212-215 with corresponding digital reference signals 259 and 269 that are associated with each of the antenna elements 204-207. The omni-directional beam-former module 222 also includes a combiner module 229 that combines corresponding I and Q data streams 241 and 243 to form an omni-directional beam-former data stream. Optionally, the omni-directional beam-former data stream may be converted to an omni-directional log-video output 234.

The quadrature converter 225 includes in-phase and quadrature components 251 and 261 that receive the digital data streams 236-239 to produce corresponding sets of I and Q data streams 241 and 243. The in-phase components 251 include mixers 255 and local oscillators 257 associated with each of the data streams 236-239 in input channels 212-215. The local oscillators 257 produce the reference signals 259 in a digital format. The reference signals 259 are joined by mixers 255 with the corresponding digital data streams 236-239. The quadrature components 261 include mixers 265 and local oscillators 267 associated with each data stream 236-239. The local oscillators 267 produce digital reference signals 269 that are joined by mixers 265 with corresponding digital data streams 236-239. The local oscillators 257 and 267 within the in-phase and quadrature components 251 and 261 may utilize LUTs as explained above in connection with the directional beam-former module 220.

The quadrature converter 225 generates the reference signals 259 of the in-phase components 251 at a phase that is offset from one another by the amount of phase delay introduced by the cabling and subsequent stages of each channel 212-215. These offsets will have been previously determined by the receive calibration processing sequence. By introducing the offsets into each channel the effective phase difference between channels would be zero degrees defined at the antenna reference plane. It is understood that the quadrature converter 225 also generates the reference signals 269 of the quadrature components 261 with a similar relationship as the in-phase reference signals 259 but shifted 90°. By maintaining this relationship of reference signals, within the in-phase components 251, and the corresponding reference signals 259, within the quadrature components 261, the quadrature converter 225 forms an omni-directional receive pattern having equal gain or sensitivity in all directions.

The combiner module 229 includes a summer 245 that sums the I data streams 241 and passes the summed I data to a low-pass filter 247 that passes only the low frequency component of the summed I data to a square calculation module 249. The Q data streams 243 are passed through a summer 253 that sums the Q data streams from each of the channels 212-215 and provides the summed Q data to a low-pass filter 263 which passes only the low frequency component of the summed data to a square calculation module 273. Outputs of the square calculation modules 249 and 273 are passed into a summer 275 which sums the signals to form an omni-directional beam-former data stream. The summer 275 provides the directional beam-former data stream to a logarithmic calculation module 271. The logarithmic calculation module 271 produces an omni-directional log-video output 234 which is no longer linear, but instead represents a logarithmic representation of the incoming data stream from the summer 274.

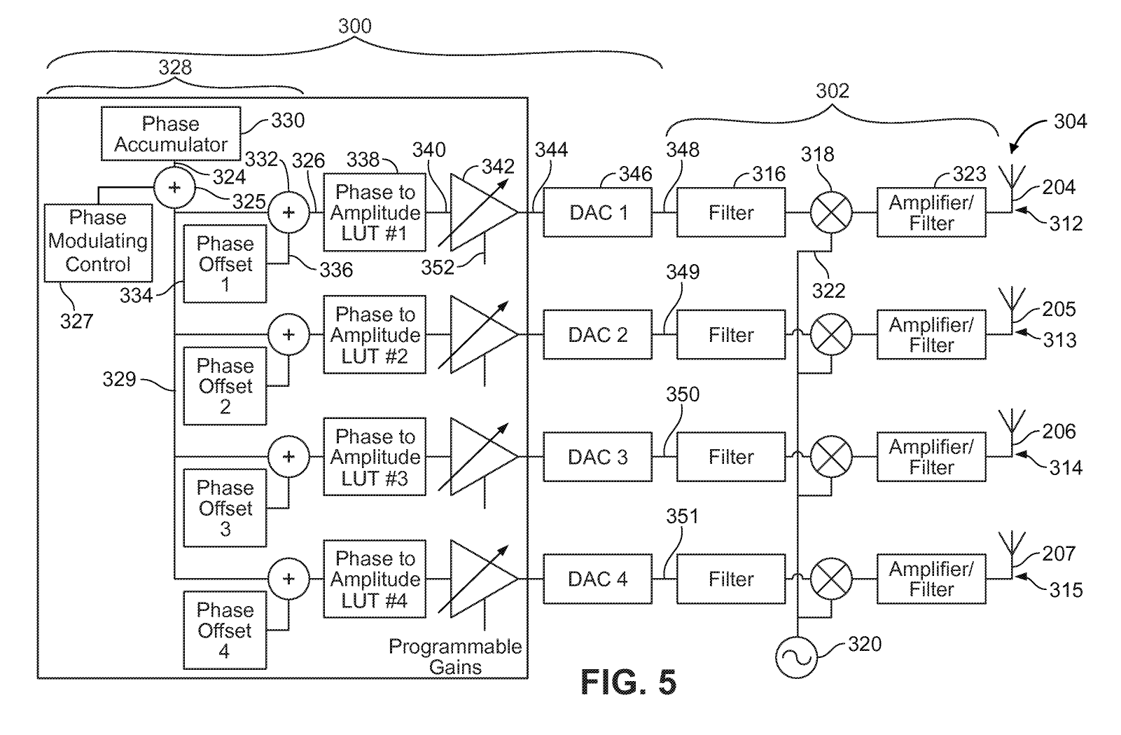

FIG. 5 illustrates a block diagram of a Direct Digital Synthesizer (DDS) module 300 that is joined to the analog transmit module 302 in accordance with an embodiment of the present invention. The DDS module 300 includes multiple output taps 348-351 that generate transmit signals for the antenna elements 204-207. Optionally, more or fewer taps 348-351 and antenna elements 204-207 may be used. For example, three or more taps may be used in a TAS or TCAS system. Each of the taps 348-351 may have different phase offsets and/or amplitudes, but will have a common frequency. Applying a zero degree phase difference between each antenna element 204-207, defined at the antenna reference plane, would form an omni-directional pattern. Thus, when the phases from all of the taps 348-351 include the appropriate offsets as defined by a transmit calibration processing sequence that compensates for the insertion phase introduced by subsequent stages and cabling, the transmit pattern is omni-directional. Optionally, a subset of the taps 348-351 may transmit at one point in time, thereby providing a transmit signal that is directional. When at least two taps 348-351 output transmit signals at one point in time and the phase between the transmit signals are offset from one another, defined by the antenna element (204-207) geometry and the calibration offsets, then a directional transmit pattern is also formed. All elements may be used together for a directional interrogation to get the best shaped beam patterns.

The DDS module 300 includes a phase control module 328 that generates digital reference counter values 326. The phase control module 328 is also programmable to adjust a common phase component of the transmit signals based on a starting point of the reference counter values 326.

The phase control module 328 includes a single phase accumulator 330 that produces a digital stream of baseline counter values 324. The frequency is set by the increment value given to the phase accumulator 330. The phase accumulator 330 outputs the baseline counter values 324 at a phase (e.g., the starting value of the counter) that is common to all of the channels 312-315. The phase accumulator 330 increments the baseline counter value by a desired amount (e.g., 20, 30 and the like) known as the increment step through a predetermined range. The phase accumulator 330 increments through the predetermined range by the increment step and, upon reaching the end of the range, it rolls over. For example, if the predetermined range of the counter is 0 to 255, inclusive, and the increment step is 10, then a subsection of the sequence output from the phase accumulator 330 is the following: 230, 240, 250, 4, 14, 24. The baseline counter values 324 output by the phase accumulator 330 are provided to a summer 325 which sums them with the output of the phase modulation control module 327 which is there to produce phase modulation of the signal. The common offset counter values 329 output by the summer 325 are provided to a plurality of summers 332 associated with each of the channels 312-315. Each summer 332 sums the common offset counter values 329 with a phase offset value 336 from a corresponding phase offset module 334.

A phase difference between the signals transmitted at antenna elements 204-207 creates an increased transmit gain (or focus the transmit beam) in a direction relative to, and extending from, the corresponding antenna elements 204-207. Thus, the phase offset modules 334 adjust the phase offset values 336 to produce transmit signals 340 with difference phases based on the calibration offsets that compensate for the insertion phase of each of the subsequent stages and cabling, and based on the antenna geometry which will define the radiation patterns (e.g., omni-directional or directional).

The summers 332 output transmit phase signals 326 that are provided to the Phase-to-Amplitude Look-Up Tables (P/A LUT) 338. Each P/A LUT 338 stores a digital representation of a sine wave. The P/A LUTs 338 translate the transmit phase signals 326 to sine wave signals that are output as transmit signals 340. The transmit signal 340 output from the P/A LUT 338 is subsequently modified by amplifier 342 by a scaling factor 352 that defines the power level of each particular channel. The scaling factors 352 are controlled to balance power from all channels and to shape the pulses. Amplitude adjusted transmit signals 344 are supplied to Digital-to-Analog Converters (DAC) 346 that convert the transmit signals 344 to analog transmit signals to be output at taps 348-351. Each of the taps 348-351 correspond to a different transmit channel 312-315, respectively.

The analog transmit module 302 is connected to the antenna elements 204-207 that are coupled to separate transmit channels 312-315. As indicated in FIG. 1, the analog transmit module may instead be attached to the full antenna module 20. Each transmit channel 312-315 includes a filter 316 that receives a corresponding analog transmit signal from one of the taps 348-351. The filters 316 constitute bandpass filters that pass Intermediate Frequency (IF) signals (e.g., 75 MHz). The IF signals from filters 316 are mixed, at mixers 318, with a local oscillator signal 322 that is generated by a local oscillator 320 to up-convert the frequency. The mixers 318 output up-converted transmit signals at a desired transmit frequency (e.g., 1030 MHz). The up-converted transmit signals from the mixers 318 are passed through amplifiers/filters 323 that increase the power of the transmit signals to a desired level to drive the corresponding antenna elements 204-207 as well as provide the appropriate spectral filtering.

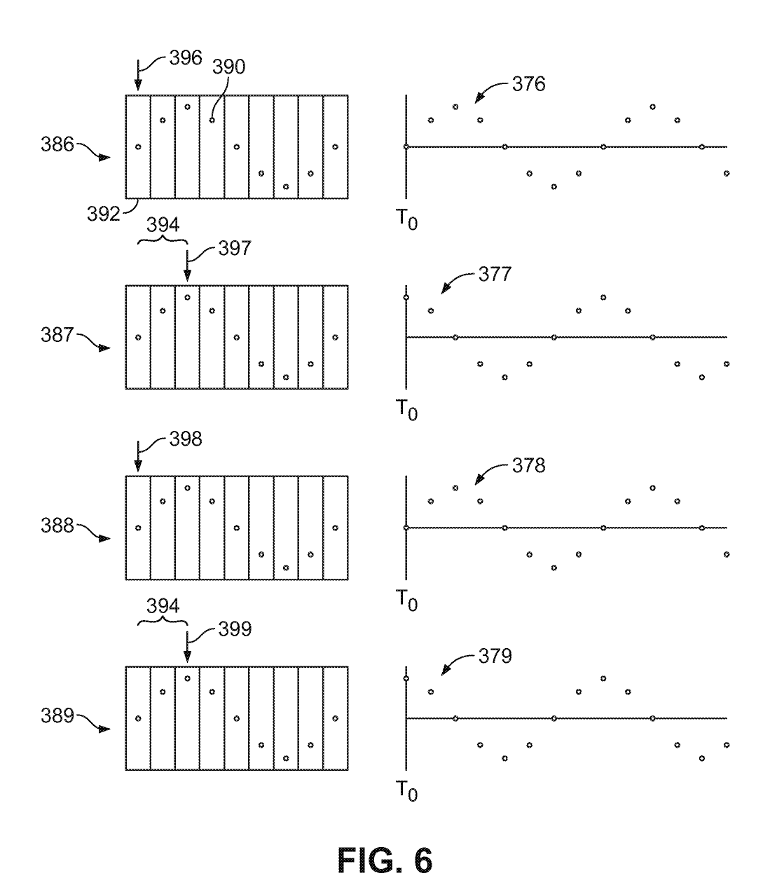

FIG. 6 illustrates a graphical representation of a set of Look-up Tables (LUTs) 386-389 that may be used as the implementation of the P/A LUTs 338 in the DDS 300 (FIG. 5). A separate LUT 386-389 is used for each transmit channel 312-315. The LUTs 386-389 store digital data values 390 at LUT addresses 392 that correspond to the data points along one or more cycles of a reference transmit signal, such as a sine wave. By way of example, each of the look-up tables 386-389 may store a common sine wave. It is understood that a substantially greater number of data values 390 may be utilized than the number shown in FIG. 6 and therefore the adjacent data values will be separated by a substantially smaller intervals than 45°. The data values 390 are read out from corresponding LUTs 386-389 based on the locations of pointers 396-399, respectively. In FIG. 6, the pointers 396-399 are shown at a representative point in time, such as a starting point. The pointers 396-399 may not point to a common address in all of the look-up tables 386-389. Instead, the pointers 396-399 are shown to point to LUT addresses 392 that are offset 394 with respect to one another in a manner in accordance with phase offset values 336. The phase offset values 336 can be based on a desired directional transmit pattern determined by the antenna geometry and the calibration which corrects for insertion phase. The offsets 394 between LUT addresses 392 in the LUTs 386-389 introduce a phase difference between transmit signals 340 (FIG. 5).

The pointers 396-399 correspond to the reference counter output 326 of the summers 332 (FIG. 5). The reference counter values 326 define the pointers 396-399 into the LUTs 386-389 to access the LUT addresses 392. By way of example in FIG. 6, the LUTs 386-389 correspond to the P/A LUTs 338 (FIG. 5) labeled #1 to #4, respectively, and the pointers 396-399 correspond to the phase offset module 334 labeled #1 to #4, respectively. The pointers 396 and 398 for LUTs 386 and 388 have no phase offset indicating that the phase offset modules #1 and #3 are set to zero. The pointers 397 and 399 for LUTs 387 and 389 have an approximate 90° phase offset with respect to the pointers 396 and 398, thereby indicating that the phase offset modules #2 and #4 are set to a phase offset value corresponding to an approximate 90° phase shift between modules #1 and #3 with respect to modules #2 and #4. Optionally, the phase offsets 336 from each of the phase offset modules 334 (#1-#4) may be a common value and thus, the pointers 396-399 would be in phase with one another and point to a common LUT address 392 within corresponding LUTs 386-389. The phase offsets may be different than the previous examples of 90° or 0° difference depending on insertion phase compensation and antenna geometry.

The LUTs 386-389 output transmit signals 376-379 that correspond to the transmit signals 340 in FIG. 5.

Next, exemplary equations will be presented in connection with transmitting a directional signal with an Intermediate Frequency (IF) frequency f, common phase Φ_{c}, phase offsets Φ₁ to Φ₄, amplitude A, time t, and a heading θ. In the equations below, values S1 to S4 correspond to the output from each of the taps 348-351, respectively. The heading in the following example is defined from −180° to +180° with 0° corresponding to the heading H (FIG. 4) straight-ahead (fore). Positive angles are to the right of the heading and negative angles are to the left of the heading. The phase offsets Φ₁ to Φ₄ include correction for insertion phase of the subsequent stages and cabling and correspond to phase offsets 334 labeled #1 through #4. Optionally, the antenna array may be rotated by 45° for installation purposes or antenna design. When the antenna array is rotated 45°, the following equations are to be updated accordingly.

$$DDS 1 \text{:}$$

$$S 1 = A cos ( tf 2 π + ( {φ}_{c} + {φ}_{1} ) \frac{π}{180 °} + cos ( ( - θ + 135 ° ) \frac{π}{180 °} ) \frac{π}{2 \sqrt{2}} )$$

$$DDS 2 \text{:}$$

$$S 2 = A cos ( tf 2 π + ( {φ}_{c} + {φ}_{2} ) \frac{π}{180 °} + cos ( ( - θ - 135 ° ) \frac{π}{180 °} ) \frac{π}{2 \sqrt{2}} )$$

$$DDS 3 \text{:}$$

$$S 3 = A cos ( tf 2 π + ( {φ}_{c} + {φ}_{3} ) \frac{π}{180 °} + cos ( ( - θ - 45 ° ) \frac{π}{180 °} ) \frac{π}{2 \sqrt{2}} )$$

$$DDS 4 \text{:}$$

$$S 4 = A cos ( tf 2 π + ( {φ}_{c} + {φ}_{4} ) \frac{π}{180 °} + cos ( ( - θ - 45 ° ) \frac{π}{180 °} ) \frac{π}{2 \sqrt{2}} )$$

If the amplitude is simply pulse modulated without any pulse shaping, strong harmonics may be produced by the DACs which could need to be filtered by analog circuitry to meet transmission spectrum requirements. Optionally, the gains may have a common gain component that allows for smoothed, low-harmonic pulse shaping of the transmit signals. Proper pulse shaping of the transmit signals improves the spectrum use of the DDS module 300 and eases the requirements on the analog filters.

In accordance with certain embodiments, a single transmit DDS is provided with multiple phase taps to create transmit signals for each antenna element. The transmit signals from the DDS are up-converted, filtered and amplified independently of one another.

While the invention has been described in terms of various specific embodiments, those skilled in the art will recognize that the invention can be practiced with modification within the spirit and scope of the claims.

What is claimed is:

1. A digital receiver for an aircraft collision avoidance system, comprising:
a plurality of antenna elements arranged within a predetermined antenna element geometry;
an analog-to-digital module to convert analog signals received by the antenna elements to uncompressed, linear digital data and outputting separate digital data streams corresponding to each of the antenna elements;
a converter module to mix the digital data streams with corresponding digital reference signals to produce digital In-phase (I) and Quadrature (Q) data streams associated with each of the antenna elements, the reference signals having phase differences there between; and
a combiner module to combine the I and Q data streams to form a directional or omni-directional beam-former data stream.

2. The digital receiver of claim 1, further comprising a log module receiving and converting the beam-former data stream to a log-video data stream, the beam-former data stream representing a non-logarithmic, non-compressed data stream prior to conversion at the log module.

3. The digital receiver of claim 1, further comprising
a first summer to sum the I data streams,
a second summer to sum the Q data streams to form summed I and Q data streams that are uncompressed and linear,
one or more low-pass filters operable to low-pass filter the summed I data and the summed Q data streams to produce filtered I data and filtered Q data,
one or more square calculation modules operable to square the filtered I data and the filtered Q data to produce squared I data and squared Q data, and
a third summer operable to sum the squared I data and squared Q data to produce the beam-former data stream.

4. The digital receiver of claim 1, wherein the converter module includes a plurality of look-up tables, each of the look-up tables storing a digital representation of the reference signal, the converter module addressing the look-up tables at addresses that are offset with respect to one another in order to define a phase difference between the reference signals.

5. The digital receiver of claim 1, wherein the converter module includes local digital oscillators that produce digital oscillator signals representing the reference signals.

6. The digital receiver of claim 1, wherein the converter module includes, in connection with each antenna element, first and second look-up tables storing representations of a common reference signal, the converter module accessing the first and second look-up tables in an offset manner that defines a phase shift of approximately 90° to form in-phase and quadrature reference signals.

7. The digital receiver of claim 1, wherein the converter module includes a plurality of re-writable look-up tables, each of the look-up tables storing a digital representation of the reference signal, the converter module addressing the look-up tables generally simultaneously in a generally sequential order to produce in-phase reference signals, the phase of each in-phase reference signal being defined by digital data values stored in one or more addresses of each look-up table, and sub-modules to delay each in-phase signal to produce quadrature reference signals which lag behind the in-phase reference signals by approximately 90°.

8. The digital receiver of claim 1, wherein:
the reference signals include first and second in-phase reference signals to be mixed with first and second digital data streams from corresponding first and second antenna elements to produce the I data streams, and
the reference signals include first and second quadrature reference signals to be mixed with first and second digital data streams from corresponding first and second antenna elements to produce the Q data streams, the first and second quadrature reference signals lagging behind their corresponding in-phase reference signals by approximately 90°.

9. A method for controlling a receiver within an aircraft collision avoidance system, comprising:
receiving uncompressed, linear analog signals, from antenna elements located within a predetermined antenna element geometry;
converting each of the linear analog signals to uncompressed, linear digital data and outputting separate digital data streams corresponding to each of the input channels;
mixing the digital data streams with corresponding digital reference signals to produce digital In-phase (I) and Quadrature (Q) data streams associated with each of the antenna elements, the reference signals having phase differences there between; and
combining the I and Q data streams to form a directional or omni-directional beam-former data stream.

10. The method of claim 9, further comprising logarithmically converting the beam-former data stream to a log-video data stream, the beam-former data stream representing a non-logarithmic, non-compressed data stream prior to logarithmic conversion.

11. The method of claim 9, further comprising
summing the I data streams,
summing the Q data streams to form summed I and Q data streams, respectively, that are uncompressed and linear,
low-pass filtering the summed I data and the summed Q data streams to produce filtered I data and filtered Q data,
squaring the filtered I data and the filtered Q data to produce squared I data and squared Q data, and
summing the squared I data and squared Q data together to produce the beam-former data stream.

12. The method of claim 9, wherein the mixing includes accessing a plurality of look-up tables, each of the look-up tables storing a digital representation of the reference signal, the look-up tables being accessed at addresses that are offset with respect to one another in order to define a phase difference between the reference signals.

13. The method of claim 9, wherein the mixing includes producing digital oscillator signals representing the reference signals.

14. The method of claim 9, further comprising storing, in first and second look-up tables associated with one of the antenna elements, representations of a common reference signal, and accessing the first and second look-up tables in an offset manner that corresponds to a phase shift of approximately 90° to form in-phase and quadrature reference signals.

15. The method of claim 9, further comprising storing, in a plurality of re-writable look-up tables, digital values defining the reference signal and accessing the look-up tables generally simultaneously in a generally sequential order to produce in-phase reference signals at a desired frequency, the phase of each in-phase reference signal being defined by the digital data values stored in one or more addresses of each look-up tables, and delaying each in-phase signal to produce quadrature reference signals which lag the in-phase reference signals by approximately 90°.

16. The method of claim 9, further comprising:
mixing first and second in-phase reference signals with the first and second digital data streams from corresponding first and second antenna elements to produce the I data streams, and
mixing first and second quadrature reference signals with the first and second digital data streams from corresponding first and second antenna elements to produce the Q data streams, as a subset of the reference signals, the first and second quadrature reference signals lagging behind their corresponding in-phase signals by approximately 90°.

17. A digital transmitter for an aircraft collision avoidance system, comprising:
a phase control module to generate digital reference counter values which includes a single phase accumulator as a reference of phase, the phase control module being programmable to adjust a frequency and phase of the reference counter-values;
phase-to-amplitude (P/A) module receiving the reference counter values and producing, based thereon, separate digital transmit signals for each of a plurality of antenna elements; and
digital-to-analog (D/A) converters converting the digital transmit signals to analog transmit signals to drive the antenna elements.

18. The transmitter of claim 17, further comprising a phase modulation control module connected to the single phase accumulator, the phase modulation control module introducing, into the reference counter values, a phase offset common to all channels that is operable to be used to modulate the phase of the transmitted signal.

19. The transmitter of claim 17, further comprising phase offset modules associated with each of the antenna elements, the phase offset modules introducing, into the reference counter values, offsets associated with corresponding ones of the transmit channels.

20. The transmitter of claim 17, further comprising programmable amplifiers associated with each of the antenna elements, the amplifiers adjusting a gain of the transmit signals for corresponding antenna elements.

21. The transmitter of claim 17, wherein the P/A modules include Look-Up Tables (LUTs) that store a digital representation of the transmit signals.

22. The transmitter of claim 17, wherein the P/A modules include Look-Up Tables (LUTs) that store a digital representation of the transmit signals, the reference counter values defining pointers into the LUTs to access addresses.

23. The transmitter of claim 17, wherein the P/A module includes a plurality of Look-Up Tables (LUTs), each of the LUTs storing a digital representation of the reference signal, the P/A module addressing the LUTs at addresses that are offset with respect to one another in order to define a phase difference between the transmit signals.

24. The transmitter of claim 17, wherein the transmit signals include first and second transmit signals to produce a phase relationship in transmit signals conveyed from first and second antenna elements in order to create a transmit signal pattern extending from the first and second antenna elements.
